(19) United States
(12) Patent Application Publication
(10) Pub. No.: US 2025/0193048 A1
(43) Pub. Date: Jun. 12, 2025

(54) MODELING WIRELESS TRANSMISSION CHANNEL WITH PARTIAL CHANNEL DATA USING GENERATIVE MODEL

(71) Applicant: Telefonaktiebolaget LM Ericsson (publ), Stockholm (SE)

(72) Inventors: Zhao Wang, Taby (SE); Jaeseong Jeong, Solna (SE)

(21) Appl. No.: 18/841,229

(22) PCT Filed: Feb. 25, 2022
(86) PCT No.: PCT/SE2022/050201

§ 371 Date: Aug. 23, 2024

(51) Int. Cl. H04L 25/02; H04B 7/06

(52) U.S. Cl. CPC H04L 25/0204; H04B 7/0626; H04L 25/0224; H04L 25/0254

(57) ABSTRACT

A method for modeling a wireless transmission channel (200) is presented, the method comprises obtaining a partial uplink, UL, channel data set (230) and obtaining a partial downlink, DL, channel data set (220). The partial UL channel data set (230) and the partial DL channel data set (220) are processed to provide reconstructed channel data set for UL and DL. The reconstructed channel data set for UL and DL is provided for subsequent communication in a wireless system (10). An associated apparatus, control node and computer software product are also presented.

### TECHNICAL FIELD

The present disclosure relates to channel modelling and more precisely to a method for modeling of a wireless channel based on partial channel data.

### BACKGROUND

Modern wireless communication systems are continuously evolving and uplink (UL) and downlink (DL) throughput is increasing. Techniques involving multiple antennas and beamforming are utilized to significantly increase the data rates and reliability of wireless communication system. The performance is improved if both the transmitter and the receiver are equipped with multiple antennas, which results in a multiple-input multiple-output (MIMO) communication channel. Such systems and/or related techniques are commonly referred to as MIMO.

The advent of MIMO has led to the introduction of advanced antenna systems (AAS). AAS typically comprise a high number of antenna elements, e.g. at both the transmitter and receiver, and are considered in recent standards of e.g. LTE and NR. For example, an AAS makes it is possible to exploit the spatial degrees of freedom offered by the multipath fading in a wireless channel in order to provide a substantial increase in the data rates and reliability of wireless transmission.

By applying different precoders to different signals to be transmitted, several signals can be transmitted simultaneously thereby greatly increasing the overall throughput. However, in order to transmit several signals simultaneously, without the signals interfering at receiving entities, the transmitting entity typically requires knowledge of the transmission channel. This means that the transmission channel needs to be modeled. Based on the modelled transmission channel, the signal to be transmitted is processed to compensate of gain and phase effects imposed by the transmission on the transmitted signal. If the channel model is partial, i.e. flawed, incomplete or otherwise lacking, the transmitted signal may disturb other devices in the wireless communication system. The transmitter signal may be incorrectly received causing retransmissions and transmitted signal may be transmitted at an overly high signal power to compensate for losses due to the poor channel mode.

Some research related to the issue of partial channel knowledge has been presented in the existing art. This research typically aims at providing a rough estimate of the missing channels based on the partial channel knowledge. For instance, in the case of partial ranks, a state of art algorithm generally assumes that the missing ranks come from the null space of the received channel matrix. In the case of partial bandwidth, a state of art algorithm assumes that the frequency dependent channel is fully captured by that sounded narrow bandwidth. However, evaluations show that the performance of these algorithms is lacking. State of art deep learning solutions generally aim for channel mapping or channel compression which rely on homogeneous input and output, e.g., channel matrix, to train a neural network. This approach typically enforces certain constraints in the system, for instance, cooperative training between gNB and UE, or the relationship on the number of dimensions in the input and output. These limitations may introduce challenges for implementations, in particular for real-time processing.

### SUMMARY

It is in view of the above considerations and others that the various embodiments of this disclosure have been made. The present disclosure therefor recognizes the fact that there is a need for improvement of the existing art described above.

An object of the present disclosure is to provide a new type of channel modeling. Advantageously, the new type of channel modelling should improve over the prior art and eliminate, or at least mitigate, the drawbacks discussed above. More specifically, an object of the invention is to provide a method for channel modeling that utilizes available data when providing the channel model more efficiently. These objects are addressed by the technique set forth in the appended independent claims with preferred embodiments defined in the dependent claims related thereto.

In a first aspect, a method for modeling a wireless transmission channel is presented. The method comprises obtaining a partial uplink, UL, channel data set, and obtaining a partial downlink, DL, channel data set. The method further comprises processing the partial UL channel data set and the partial DL channel data set to provide reconstructed channel data set for UL and DL. The method also comprises providing said reconstructed channel data set for UL and DL for subsequent communication in a wireless system.

In one variant, the partial UL channel data set is a partial UL channel matrix obtained based one or more Sounding Reference Signals, SRS, relating to the UL. This is beneficial as SRS are readily available in many different radio access technologies (RAT).

In one variant, the partial DL channel data set is obtained based one or more channel state information, CSI, feedback relating to the DL. This is beneficial as CSI feedback is readily available in many different radio access technologies (RAT).

In one variant, the CSI feedback is Type-I codebook based feedback and/or Type-II codebook based feedback.

In one variant, processing the partial UL channel data set and the partial DL channel data set comprises applying a generative model. The generative model comprises a generative function with (i.e. taking, accepting etc.) the partial UL channel data set and the partial DL channel data set as inputs. This is beneficial as generative models are powerful tools to effectively solve underdetermined problems.

In one variant, the generative function is a feedforward neural network.

In one variant, the method further comprises training the generative model.

In one variant, training the generative model comprises iteratively mapping a channel data set target to a hybrid channel data set. The hybrid channel data set comprises UL channel data not comprised in the partial UL channel data set and/or DL channel data not comprised in the partial DL channel data set. The training further comprises mapping the channel data set target, the partial UL channel data set and the partial DL channel data set to a probability measure. The iteration is continued until a convergence criterion is met at which point a generative function is provided based on the hybrid data set.

In one variant, mapping the channel data set target further comprises mapping the channel data set target to a random variable. This is beneficial as it improves the accuracy and the generalization capability of the provided generative function.

In one variant, the random variable is sampled from a multi-dimensional Gaussian distribution. This is beneficial as it improves the accuracy and the generalization capability of the provided generative function.

In one variant, said subsequent communication in the wireless system comprises beamforming at least one of a UL transmission or a DL transmission based on the reconstructed channel data set. Beamforming based on the reconstructed channel data set will, due to e.g. the additional data of the reconstructed channel data set, increase an SNR at the receiver (allows for decrease of transmit power, reduce risk of retransmission and thereby increase spectrum efficiency etc.), reduce a risk of interfering with other devices and allow for an increased throughput.

In one variant, the transmission channel comprises a plurality of sub-channels and the partial UL channel data set is limited to a subset of said plurality of sub-channels. This is beneficial as full channel knowledge may be provided with only a limited number of sub-channels being measured.

In one variant, the transmission channel comprises a plurality of sub-channels and the partial DL channel data set is limited to a subset of said plurality of sub-channels. This is beneficial as full channel knowledge may be provided with only a limited number of sub-channels being measured.

In one variant, the sub-channels are configured with different center frequencies.

In one variant, the sub-channels are configured with different bandwidth.

In one variant, the sub-channels are configured with different modulations.

In one variant, the partial DL channel data set is limited in a spatial domain with respect to the wireless transmission channel. This is beneficial as full channel knowledge may be provided with only a limited number of directions, phases etc. of beams being measured.

In one variant, the partial UL channel data set is limited in space with respect to the wireless transmission channel. This is beneficial as full channel knowledge may be provided with only a limited number of directions, phases etc. of beams being measured.

In a second aspect, an apparatus for modeling a wireless transmission channel is presented. The apparatus is configured to cause obtaining of a partial UL channel data set and obtaining of a partial DL channel data set. The apparatus is further configured to cause processing of the partial UL channel data set and the partial DL channel data set to provide reconstructed channel data set for UL and DL and provisioning of said reconstructed channel data set for UL and DL for subsequent communication in a wireless system.

In one variant, the apparatus is configured to perform the method according to the first aspect.

In a third aspect, a control node comprising the apparatus of the second aspect is presented.

In one variant, the control node is a network node.

In a fourth aspect, a wireless communication system comprising the control node of variants of the third aspect is presented.

In a fifth aspect, a computer program product is presented. The computed program product comprises a non-transitory computer readable medium, having (stored) thereon a computer program comprising program instructions. The computer program is loadable into a data processing unit and configured to cause execution of the method according to the first aspect when the computer program is run (e.g. executed) by the data processing unit.

### BRIEF DESCRIPTION OF THE DRAWINGS

These and other aspects, features and advantages will be apparent and elucidated from the following description of various embodiments; references being made to the appended diagrammatical drawings which illustrate non-limiting examples of how the concept can be reduced into practice.

FIG. 1a is a schematic view of a wireless communication system according to embodiments of the present disclosure;

FIGS. 1b and 1c are views of advanced antenna arrays usable with embodiments of the present disclosure;

FIG. 1d is a schematic view illustrating concepts for spectrum sharing usable with embodiments of the present disclosure;

FIGS. 2a and 2b are views of a two transmit four receive antenna usable with embodiments of the present disclosure;

FIG. 3 is a schematic view of a wireless communication system according to embodiments of the present disclosure;

FIG. 4 is a schematic view of information flow according to embodiments of the present disclosure;

FIG. 5 is a block diagram of a method according to embodiments of the present disclosure;

FIG. 6 is a partial block diagram of a method according to embodiments of the present disclosure;

FIG. 7 is a partial block diagram of a method according to embodiments of the present disclosure;

FIG. 8 is a partial block diagram of a method according to embodiments of the present disclosure;

FIG. 9 is a partial block diagram of a method according to embodiments of the present disclosure;

FIG. 10 is a schematic view of a generative function according to embodiments of the present disclosure;

FIGS. 11a and 11b are schematic views of an apparatus according to embodiments of the present disclosure;

FIG. 12 is a schematic view of a control node according to embodiments of the present disclosure;

FIG. 13 is a schematic view of a computer program product according to embodiments of the present disclosure; and

FIGS. 14a and 14b are schematic views illustrating loading of the computer program product according to embodiments of the present disclosure.

### DETAILED DESCRIPTION

Hereinafter, certain embodiments will be described more fully with reference to the accompanying drawings. The invention described throughout this disclosure may, however, be embodied in many different forms and should not be construed as limited to the embodiments set forth herein; rather, these embodiments are provided by way of example so that this disclosure will be thorough and complete, and will fully convey the scope of the invention, such as it is defined in the appended claims, to those skilled in the art.

The term “coupled” is defined as connected, although not necessarily directly, and not necessarily mechanically. Two or more items that are “coupled” may be integral with each other. The terms “a” and “an” are defined as one or more unless this disclosure explicitly requires otherwise. The terms “substantially,” “approximately,” and “about” are defined as largely, but not necessarily wholly what is specified, as understood by a person of ordinary skill in the art. The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a method that “comprises,” “has,” “includes” or “contains” one or more steps possesses those one or more steps, but is not limited to possessing only those one or more steps.

In the present disclosure, references to a data set may, depending on context, reference a plurality of data usable for e.g. training of a generative function, or one or more data points e.g. generated by such a generative function. To the skilled person, this will be clear from the context of the reference.

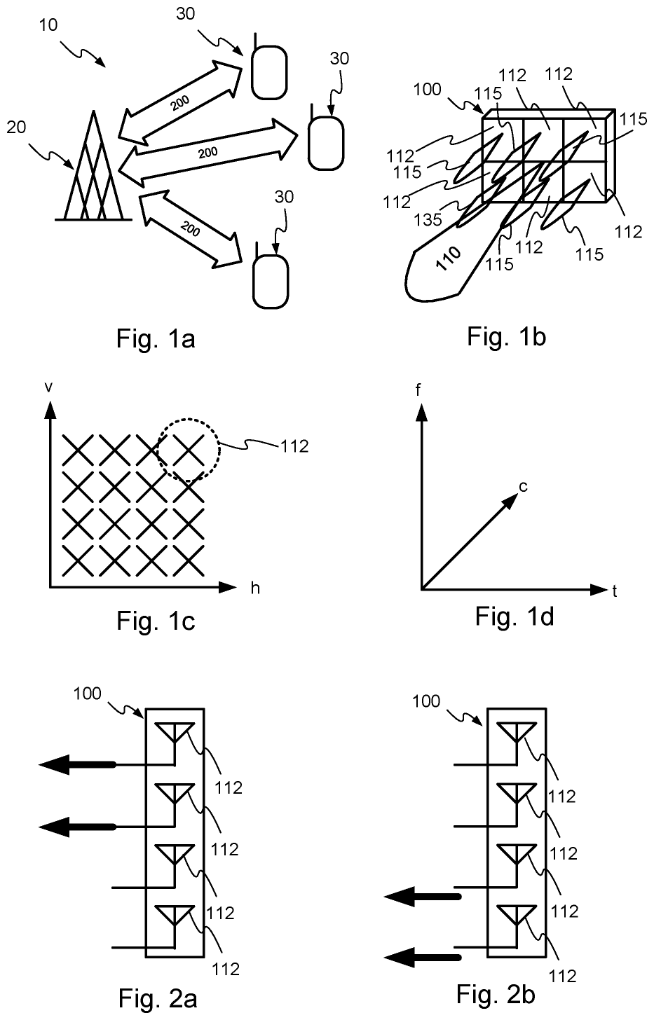

In FIG. 1a, a wireless communication system 10 is illustrated. The wireless communication system 10 comprises at least one control node 20. The control node 20 may, in some embodiments be a network node 20 and in further embodiments a base station (BS), a node B (BB), an evolved node B (eNB), a new radio (NR) node B (gNB) etc. The network node 20 is configured for communication with a plurality of wireless devices 30 such as user equipment (UE) etc. across different transmission channels 200. The multiple transmission channels are based on multipath fading.

In order to direct a transmission to a specific wireless device 30, the network node 20 comprises a plurality of antenna elements 112, see FIG. 1b. These antenna elements 112 may be comprised in an advanced antenna system (AAS) 100 which may be formed as a plurality of antenna elements 112 arranged in a matrix structure. When excited, i.e. fed with a signal, an antenna element 112 will radiate power in a sub-beam 115. As more than one antenna element 112 is excited, their respective sub-beams 115 will positively or negatively interfere with each other forming a beam 110. Each of the antenna elements 112 may be excited individually with regards to phase and amplitude in order to direct the beam 110 towards an intended recipient of a signal carried by the beam 110.

In FIG. 1c, an AAS 100 comprising v×h=4×4=16 antenna elements 112 is shown. The AAS of FIG. 1c is a two-dimensional antenna array usable with the teachings of the present disclosure but the teaching are not limited to two-dimensional antenna arrays. Generally, two-dimensional antenna arrays may be (partly) described by the number of antenna columns corresponding to the horizontal dimension Nₕ, the number of antenna rows corresponding to the vertical dimension Nᵥ and the number of dimensions corresponding to different polarizations Nₚ. The antenna elements 112 of FIG. 1c are cross-polarized which means that each antenna element 112 may transmit and receive signals with two different polarizations. The total number of individual antennas, or transmit/receive paths in the AAS is thus N=NₕNᵥNₚ. It should be pointed out that the concept of an antenna is non-limiting in the sense that it can refer to any virtualization (e.g., linear mapping) of the physical antenna elements 112. For example, pairs of physical sub-elements could be fed the same signal, and hence share the same virtualized antenna port.

The AAS 100 may consequently be utilized to direct a beam 110 towards a receiving entity, and the AAS 100 may be configured to simultaneously transmit a plurality of different beams 110 in different directions.

Each beam 110 may in fact be divided between different transmitted (or received) signals. That is to say, the signal spectrum of the beam may be configured for multiple signals. These signals may be separated in, as is well known to the skilled person, at least one or more of time t (e.g. time division duplex, TDD), frequency f (e.g. frequency division duplex, FDD) or coding c (e.g. code division multiple access, CDMA), this is illustrated in FIG. 1d. In addition to this, different bandwidths, modulation, bitrates etc. may be utilized when transmitting the signals. All these factors may affect how the transmission channel behaves and consequently how the transmission channel 200 affects the transmitted signal.

In order to reduce the effects of the transmission channel 200, the transmitted signal is processed to compensate for the effects of the transmission channel. This concept is generally known as precoding. Precoding may be interpreted as multiplying the signal with different beamforming weights for each antenna element 112 prior to transmission. A typical approach is to tailor the precoder to the antenna form factor, i.e. taking into account the horizontal dimension Nₕ the vertical dimension Nᵥ and the different polarizations Nₚ when designing a precoder codebook.

Consequently, a key point for effective deployment of Multiple Inputs Multiple Outputs (MIMO) communication technology is access to estimate of the channel responses between the network node 20 and the wireless devices 30 in an associated network cell of the communications network 10. This estimate of the transmission channel 200 is generally known as channel state information (CSI). These channel responses generally include responses for both downlink (DL) and uplink (UL) transmissions and assist in forming the beam 110 from the network node 20 towards the intended wireless devices. The channel in the UL direction is usually estimated using pilot symbols (reference signals) sent by the wireless device 30 and received by the network node 20. This method is commonly known as sounding and is implemented as Sounding Reference Symbols (SRS) in 3GPP LTE and NR.

Generally, the more signals that are to be transmitted simultaneously, the more complex the channel model and precoder as more interferences need to be cancelled. The complexity also comes in the play when receiving signals. If several signals are received at a same time, combining complexity of the signals will increase and the receiver processing has to be configured accordingly. The complex AAS 100 related processing in UL and DL introduces heavy processing loads on transmitting and receiving entities. Increased processing leads to increased energy consumption, increased heat dissipation increasing the need for cooling which, as a need for more powerful processing units, increase the cost, weight and volume of the entity.

For a TDD-based system with a common frequency for UL and DL, it is possible to apply the physical channel property of reciprocity and use the UL sounding and channel estimation to obtain the DL channel estimates as well. The DL channel estimate may be used to calculate the beamforming weights. Generally, reciprocity-based algorithms for beamforming in the DL are amongst the most successfully exploited algorithms in MIMO and are predicted to be widely exploited in the fifth generation of cellular wireless communication networks. This class of algorithms are applicable whenever the so-called channel reciprocity holds. More precisely, these reciprocity-based algorithms for beamforming in the DL assume that the UL channel response of the transmission channel 200 is the same as the DL channel response of the transmission channel 200. These assumptions are considered valid also with a change in transmitter and receiver and typically disregarding output power differences. Using these assumptions, these algorithms use the estimated channel in the UL direction for beamforming in the DL. This principle holds, when time-division multiplexing is used for sharing data transmission time between the DL and UL transmissions. In summary, in reciprocity-based beamforming, based on a previously transmitted pilot symbol from the wireless device 30 to the network node 20, the UL channels are estimated. These estimates are considered valid also in the DL channels by transposing channel matrices describing the DL channels.

CSI measurement on uplink SRS are important for massive MIMO systems. For instance, in NR, SRS has been designed for multiple use cases in which antenna switching is mainly targeted at channel sounding for reciprocity-based MIMO transmission. Depending on the different UE capabilities, i.e. 1T2R, 1T4R, 2T4R, 4T4R etc. The SRS is transmitted with various resource settings, where T and R represents transmission antenna and receiving antenna respectively, and the number indicating the number of antenna chains.

In FIGS. 2a and b, an exemplary 2T4R antenna switching is presented. The 2T4R may be comprised in a wireless device 30. Antenna switching is generally implemented in order to test all antenna elements 112 of a multi-antenna device such as an AAS 100 or the simpler multi-antenna 100 of Figs. As only two transmit paths are available, not all four antenna elements 112 may be configured to transmit at the same time. Consequently, in FIG. 2a a first 2-port resource is transmitted and in FIG. 2b, a second 2-port resource is transmitted. The first 2-port resource and the second 2-port resource are generally time mapped with a guard interval between the transmissions. Generally, all resources are tested within one timeslot, actually within the last symbols of a time slot, which is referred to as intra-slot antenna switching. However, if all the switching, i.e. all resources cannot be completed within one time-slot, this is referred to as inter-slot antenna switching. This is the case for 1T4R case where a total of seven symbols are required (four resources separated by three guard intervals) in order to complete the switching, which means that the SRS resources will not fit in the last 6 symbols of the slot and two slots are required.

It should be noted that for NR, SRS may also be configured to support different bandwidth configurations to adapt to different needs of bandwidth scheduling and resource limitations. For instance, a gNB 20 may configure a wireless device 30 to sound a full band of the scheduled bandwidth or only a sub-band of that bandwidth at specific UL slots. This flexibility provides a wide range of applications to assist reciprocity-based MIMO beamforming.

For some wireless devices 30, antenna switching may not be implemented due to e.g. cost and/or complexity. In those cases, a fixed transmission chain is generally implemented such that only a fixed subset of the antenna elements 112 of the wireless device 30 are capable of transmitting SRS. For instance, in the example of FIGS. 2a and b, only the resources in FIG. 2a may be implemented at the wireless device 30 such that only the first two antenna elements 112 are sounded. As a result of this, the network node 20 will only be provided with part of the spatial channel knowledge of the SRS estimation of the transmission channel 200.

Limited by UL resources and UL transmission power, the network node 20 may configure narrowband SRS to sound part of the intended bandwidth. In those scenarios, a large part of the frequency dependent channel knowledge is missing from network node 20 side.

The above explained reciprocity-based method for obtaining the CSI describing the transmission channel is one example. Generally, there are two main tracks for obtaining CSI which are codebook-based feedback, and the above described reciprocity-based method. In the codebook-based feedback, a network node 20 sends a training sequence, from which a wireless device 30 estimates a suitable DL precoder and feeds this data set back to the network node 20.

As previously mentioned, precoding may be interpreted as scaling (multiplying, processing) a signal with different beamforming weights for each antenna element 112 prior to transmission. A common type of precoding is to use a DFT-precoder. In DFT-precoders the precoder vector used to precode a single-layer transmission using a single-polarized uniform linear array (ULA) with N antennas is defined as

$${w}_{1 D} ( k ) = \frac{1}{\sqrt{N}} [ \begin{matrix}{e}^{j 2 π \cdot 0 \cdot \frac{k}{QN}} \\ {e}^{j 2 π \cdot 1 \cdot \frac{k}{QN}} \\ ⋮ \\ {e}^{j 2 π \cdot ( N - 1 ) \cdot \frac{k}{QN}}\end{matrix} ] ,$$

where k=0, 1, . . . QN−1 is the precoder index and Q is an integer oversampling factor. A corresponding precoder vector for a two-dimensional Uniform planar array (UPA) may be created by taking the Kronecker product of two precoder vectors as w_{2D}(k, l)=w_{1D}(k)⊗w_{1D}(l). Extending the precoder for a dual-polarized UPA may then be done as

$${w}_{2 D , DP} ( k , l , ϕ ) = [ \begin{matrix}1 \\ {e}^{j ϕ}\end{matrix} ] ⊗ {w}_{2 D} ( k , l ) = [ \begin{matrix}{w}_{2 D} ( k , l ) \\ {e}^{j ϕ} {w}_{2 D} ( k , l )\end{matrix} ] = [ \begin{matrix}{w}_{2 D} ( k , l ) & 0 \\ 0 & {w}_{2 D} ( k , l )\end{matrix} ] [ \begin{matrix}1 \\ {e}^{j ϕ}\end{matrix} ] ,$$

where e^{jϕ} is a co-phasing factor that may for instance be selected from QPSK alphabet

$$ϕ ∈ \{ 0 , \frac{π}{2} , π , \frac{3 π}{2} \} .$$

A precoder matrix W_{2D,DP} for multi-layer transmission may be created by appending columns of DFT precoder vectors as W_{2D,DP}=[w_{2D,DP}(k₁, l₁, ϕ₁) w_{2D,DP}(k₂, l₂, φ₂) . . . w_{2D,DP}(k_{R}, l_{R}, ϕ_{R})], where R is the number of transmission layers, i.e. the transmission rank. In a common special case for a rank-2 DFT precoder, k₁=k₂=k and l₁=l₂=l, meaning that

$${W}_{2 D , DP} = \begin{matrix}[ {w}_{2 D , DP} ( k , l , {ϕ}_{1} ) & {w}_{2 D , DP} ( k , l , {ϕ}_{2} ) ]\end{matrix} = [ \begin{matrix}{w}_{2 D} ( k , l ) & 0 \\ 0 & {w}_{2 D} ( k , l )\end{matrix} ] [ \text{} \begin{matrix}1 & 1 \\ {e}^{j {ϕ}_{1}} & {e}^{j {ϕ}_{2}}\end{matrix} ] .$$

In a standard codebook, the first matrix in the W_{2D,DP} is generally named W_1 and the co-phase matrix as W_2.

In addition to Type-I codebook a Type-II codebook is still evolving in current standardization processes. Despite detailed codebook design difference, both Type-I and Type-II codebook are in principle the approximation of significant singular vectors in the spatial, frequency, and time dimension of the transmission channel 200 based on a certain pre-defined vector basis (DFT vectors). These approximations expressed as the code words in the precoder codebook provide non-loss free (i.e. lossy) compression of principal components of the transmission channel 200 based on pre-defined basis (DFT vectors).

In either of the codebook-based feedback or the reciprocity-based method, the CSI may be described as comprising data related to a gain, a delay and/or an interference situation of the transmission channel 200.

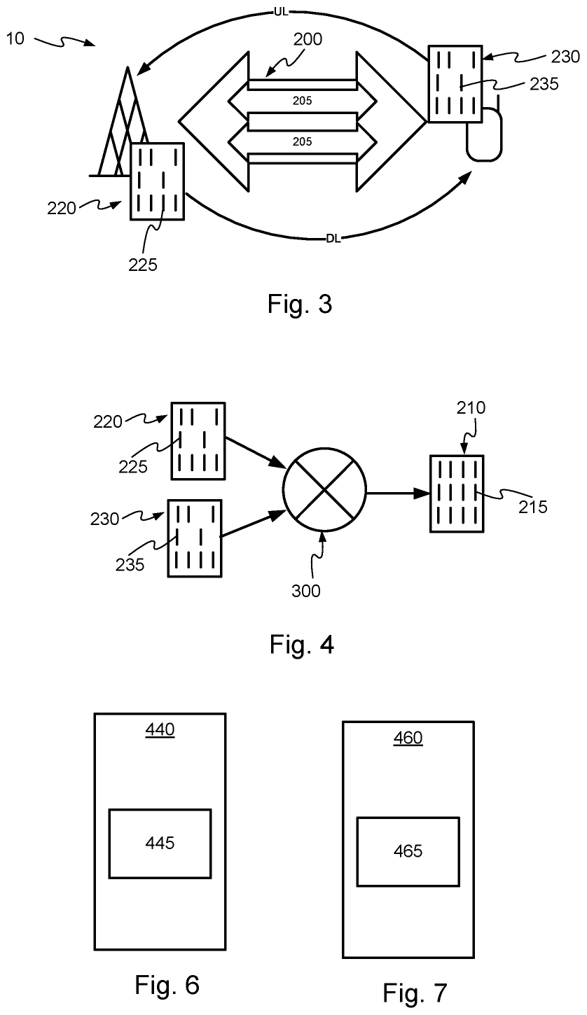

In summary, see FIG. 3, the transmission channel 200 is estimated based on one of a partial UL channel data set 230 or a partial DL channel data set 220. The partial UL channel data set 230 may be obtained from the sounding signals transmitted by the wireless device 30 as presented above. The partial DL channel data 220 may be obtained from codebook-based feedback as presented above. There may be several different aspects of the transmission channel 200 that are not part of the partial channel data 220, 230. Sounding or codebook-based feedback is generally only performed for a subset of the degrees of freedom of the transmission channel 200. The transmission channel 200 may comprise a plurality of sub-channels 205 and the partial channel data 220, 230, i.e. partial DL channel data 220 and/or partial UL channel data set 230 may e.g. only comprise UL channel data 235 and/or DL channel data 225 relating to a subset of said plurality of sub-channels 205. The sub-channels 205 may, as previously indicated, be separated in one or more of frequency c, i.e. having different center frequencies fc, modulation m and/or modulation m. In addition to this, the sub-channels 205 may be configured with different bandwidth B. These features may all affect the response of the sub-channel 205 and the term partial channel data 220, 230 is meant to comprise channel data of the transmission channel 200 where a channel estimate for one or more of these features is missing. The same is true for embodiment where the transmission channel is not comprised of a plurality of sub-channels. In some embodiments, the partial DL channel data set 220 and/or the partial UL data set 230 may be limited in a spatial domain with respect to the wireless transmission channel 200.

Partial UL channel data 230 obtained from SRS is a critical limitation for the DL beamforming performance. For scenarios wherein only part of the frequency band of the transmission channel 200 is sounded, the beamforming design is limited by the channel knowledge confined in that sounded bandwidth. This makes the design of a frequency selective precoder very challenging. For scenarios wherein only part of the antenna elements 112 of the wireless device 30 are sounded, the beamforming design is fundamentally limited by the missing ranks of the channel matrix. This makes the design precoder for higher rank transmission very challenging. The problem becomes even more severe for MU-MIMO interference nulling beamforming design.

With reference to FIG. 4, one embodiment to the teachings of the present disclosure is illustrated. The conceptual idea lies in, for a specific transmission channel 200, applying an estimation process 300 to the partial DL channel data set 220 and the partial UL channel data set 230 to obtain a reconstructed channel data set 210. The reconstructed channel data set 210 comprises reconstructed channel data 215. In this case, the sum, i.e. the reconstructed channel data set 210 is larger than it part, i.e. the partial DL channel data set 220 and the partial UL channel data set 230. This may be described as a total number of reconstructed channel data 215 in the reconstructed channel data set 210 is larger than a sum of a total number of partial UL channel data 235 of the partial UL channel data set 230 and a total number of partial DL channel data 220 of the partial DL channel data set 220. In other words, the reconstructed channel data set 210 comprises a more detailed description of the transmission channel 200 than the sum of the partial DL channel data set 220 and the partial UL channel data set 230. Or, the reconstructed channel data set 210 comprises data relating to transmission in the transmission channel 200 not comprised in either the partial DL channel data set 220 or the partial UL channel data set 230. The estimation process 300 may be implemented at any (one or more) communication node 20, 30 of the wireless communications system 10. Preferably, the estimation process 300 is implemented at one or more stationary communication nodes, such as the network node 20. The reconstructed channel data set 210 is usable for subsequent transmission and/or reception across the transmission channel 200. Preferably, the estimation process 300 is a generative model 300.

In a specific exemplary embodiment, the estimation process 300 is implemented at a communication node 20, 30 and takes the noisy partial channel knowledge, i.e. the partial UL channel data set 230 and a subset of precoders, i.e. the partial DL channel data set 220, from the CSI-feedback as input. The output of estimation process 300 is a channel matrix, i.e. the reconstructed channel data set 210, that is not possible to obtained from reference signals.

The solution presented herein, and as will be explained in detail at other sections of this disclosure, utilizes advantages of the powerful modelling capability offered by a generative model 300. A generative model 300 may generate data, e.g. the missing channel knowledge, according to a learned generation function such that the generated data and the desired data have similar distributions. In addition to this, the present solution may be configured to utilize a conditional generative model. The conditional generative model may obtain descriptions of a target as inputs. These descriptions may be the partial UL channel data set 230, i.e. channel knowledge obtained from the reference signal, and the partial DL channel data set 220, i.e. the precoder information obtained via CSI-feedback. This will allow the descriptions to provide guidance for the generative model 300.

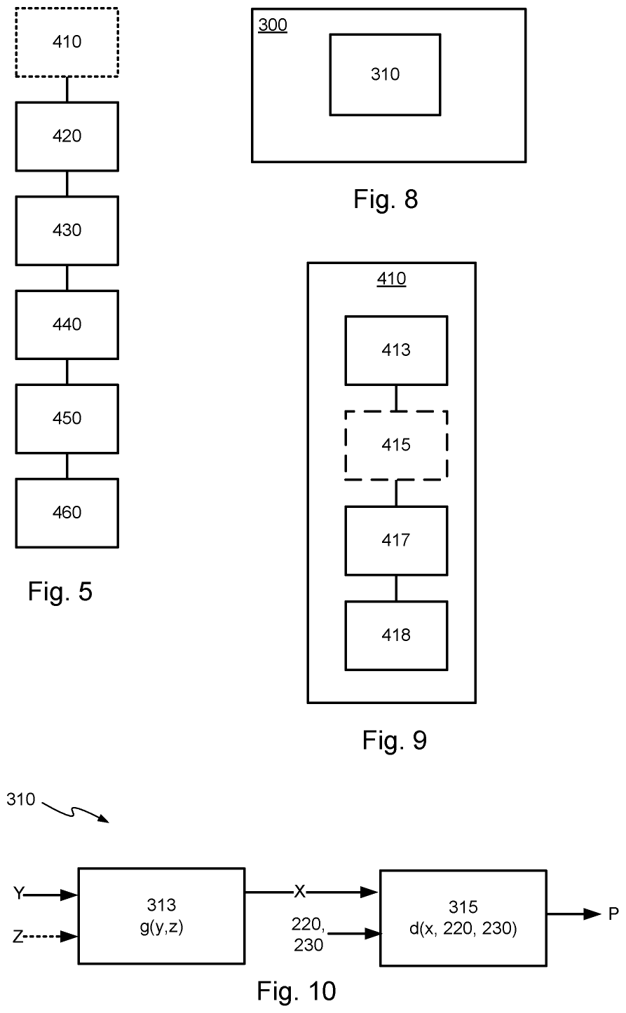

With reference to FIG. 5, one embodiment of a method 400 for modeling a wireless transmission channel 200 will be presented. The method 400 comprises obtaining 420 a partial UL channel data set 230. The partial UL channel data set 230 may be any partial UL channel data set 230 as presented herein. The partial UL channel data set 230 may comprise UL channel data 235. The partial UL channel data set 230 may be obtained from e.g. one or more SRS relating to the UL The method 400 further comprises obtaining 430 the DL channel data set 220.

The partial DL channel data set 220 may be any partial DL channel data set 220 as presented herein. The partial DL channel data set 220 may comprise DL channel data 225. The partial DL channel data set 220 may be obtained based one or more channel CSI feedback relating to the DL. In some embodiments, the CSI feedback is Type-I codebook based feedback and/or Type-II codebook based feedback.

The method further comprises processing 440 the partial UL channel data set 230 and the partial DL channel data set 220 to provide reconstructed channel data set 210 for UL and DL. The processing 440 may comprise the estimation process 300 according to any embodiment described elsewhere in the present disclosure. In some embodiments, the processing comprises applying 445, see FIG. 6, a generative model 300. The generative model 300 may take the partial UL channel data set 230 and the partial DL channel data set 220 as inputs. An output of the generative model 300 may be the reconstructed channel data set 210. The generative model 300 may comprise a feedforward neural network 310, see FIG. 8.

The method 400 further comprises providing 450 the reconstructed channel data set 210 for UL and DL for subsequent communication 460 in the wireless system 10. In some embodiments, the subsequent communication comprises beamforming 465, see FIG. 7, at least one of a UL transmission or a DL transmission based on the reconstructed channel data set 210.

Optionally, the method 400 comprises training 410 of the generative model 300. The training 410 will be briefly described with reference to Figs. but given with more technical detail elsewhere in the present disclosure, e.g. FIG. 9. Training 410 the generative model 300 may comprise mapping 413 a channel data set target x, see FIG. 10, to a hybrid channel data set y, see FIG. 10, comprising UL channel data 235 not comprised in the partial UL channel data set 230 and/or DL channel data 225 not comprised in the partial DL channel data set 220. Optionally, mapping 413 the channel data set target X may further comprise mapping 415 the channel data set target X to a random variable set Z. That is to say, mapping 413 the hybrid channel data set Y and the random variable Z to the channel data set target X. The random variable set Z may be sampled from a multi-dimensional Gaussian distribution.

The training 410 may further comprise mapping 417 the channel data set target X, the partial UL channel data set 230 and the partial DL channel data set 220 to a probability measure P. That is to say, the probability measure P indicate if the channel data set target X, i.e. a generated sample, and the original data, i.e. the partial channel data sets 220, 230 belongs to an original training data, i.e. the channel data set target X and the hybrid channel data set Y. These steps 413, 417 are preferably repeated, e.g. performed iteratively, until a convergence criterion is met. When the convergence criterion is met, i.e. when the mapping 413 of the channel data set target x converge to a certain equilibrium where the mapping 413 learns to output a realistic X, the training 410 further comprises providing 418 a generative function 310 based on the hybrid channel data set Y.

As seen in FIG. 10, the generative function 310 may comprise a generator 313. The generator 313 may be configured to perform at least part of the method 400 of FIG. 5, in particular the training 410 of FIG. 9 and more particularly the mapping 413 of a channel data target x. The generator may be described by a generator function g(y, z) of a hybrid channel data y and, optionally, a random variable z. The generative function 310 may further comprise a discriminator 315. The discriminator 315 may be configured to perform at least part of the method 400 of FIG. 5, in particular the training 410 of FIG. 9 and more particularly the mapping 417 of the probability measure P. The discriminator 315 may be described by a discriminator function d(x, y).

With continued reference to FIG. 10, some detailed embodiments according to the present disclosure will be given. The embodiment shown in FIG. 10 may be described as a conditional generative adversarial net (cGAN) framework to render a desired estimator. As previously mentioned, the cGAN comprises a generator function g(y, z) that maps the partial channel matrix, i.e. the partial UL channel data set 230, and the precoder information, i.e. the partial DL channel data set 220, in the CSI-feedback, denoted as the hybrid channel data y, and the random variable z sampled from a distribution function P_{z} to the output random variable x, i.e. the channel data target x. It is worth noting that the distribution function P_{z} may be an empty set, in which case, the generator function g(y, z) effectively only takes the hybrid channel data y as input.

The cGAN further comprises a discriminator function d(x, y) that maps the output from the generator x and original conditional data y into a probability measure [0, 1], indicating if the generated sample x and the original conditional data y belongs to the original training data set, i.e. the channel data set target X and the hybrid channel data set Y.

As previously indicated, the generator function g(y, z) and the discriminator function d(x, y) may be trained iteratively according to their own loss functions in a game theory setup. Specifically, the discriminator function d(x, y) may be trained to distinguish between the fake output of the generator function g(y, z) and true data, i.e. maximize a loss function of the generator function g(y, z). The generator function g(y, z) is trained to generate a fake output x, i.e. a channel data target x, that looks sufficiently realistic to deceive the discriminator function d(x, y), i.e. maximize the loss function of the discriminator function d(x, y). As will be understood by the skilled person after contemplating the teachings of the present disclosure, over these iterations, both the generator function g(y, z) and discriminator function d(x, y) will converge to a certain equilibrium where the generator function g(y, z) learns to output a realistic channel data target x.

After training, the generator function g(y, z) is applied in an execution phase for channel reconstruction. Preferably, the generator function g(y, z) will be deployed as the generative function 310.

Depending on applications, the data set formulation and training target may be adjusted accordingly. In the following, specific details for individual applications will be presented. These details are for explanatory purposes and the embodiments mentioned are non-limiting examples.

In one embodiment, wideband channel reconstruction based on narrow band sounding and CSI-feedback is considered in a wireless system using NR radio access technology (RAT). This embodiment aims to reconstruct the transmission channel 200 in the frequency domain f based on the partial channel knowledge 220, 230 confined in a certain narrow band. Assume that the relevant bandwidth B is divided into several narrow bands NB1-NB4. Further assume a scenario in which only a subset of the narrow bands are sounded, e.g. NB1 and NB3. The goal is to obtain an estimate of the channel matrix, i.e. the reconstructed channel data set 210, for the other bands, e.g. NB2 and NB4. This is done based on the estimation on NB1 and NB3 as well as CSI-feedback, i.e. the partial DL channel data set 220.

In order to obtain data for training the generative function 310, a gNB 20 of the wireless system 10 configure reference signals such that first reference signals (e.g., SRS) are transmitted for all the bands at a UE device 30 of the wireless system 10. The gNB may configure a second reference signal (e.g. CSI-RS) for transmitting to the UE device 30. The gNB further configures the CSI report based on the reference signal such that the CSI-feedback is generated at the UE device 30 for the reconstruction targeting bandwidth, and transmits the CSI report and the second reference signal to the UE device 30.

The gNB performs channel estimation based on the received first reference signals, i.e. the partial UL channel data set 230, in order to obtain channel estimation for the whole bandwidth. This is to provide the ground-truth data in the training phase. The gNB proceeds to decode the CSI-feedback, i.e. the partial DL channel data set 220.

In order to formulate a training set, all the channel estimates from the target bandwidth, e.g., NB2 and NB4, are labeled as data samples in the channel data set target X. Channel estimates from the other bandwidth (where the reference signal will be transmitted in the execution phase), e.g, NB1 and NB3, are labeled as UL data samples h. Further to this, all the precoders from the target bandwidth, e.g., NB2 and NB4, are labeled as the DL data samples p.

The indices of the labeled data are arranged such that xᵢ, hᵢ, pᵢ represent the channel knowledge for the same time range, e.g., the same 5 ms interval. The UL data samples hᵢ and the DL data samples pᵢ are concatenated to form a new hybrid channel data yᵢ in the new sample space of the hybrid channel data set Y. The formulated data set X, Y may be used in training the generative model 300.

The generative model 300 may be trained 410 by fixing the random distribution P_{z}, where Z is a random variable set Z from this distribution, the dimension of Z is a design parameter. As previously mentioned, the random distribution P_{z} may be chosen as a multi-dimensional Gaussian distribution. From the random distribution P_{z} a random variable z may be sampled. The generator function g(y, z) may be configured to map the random variable z and a data point yᵢ to the output x*ᵢ the channel data target x, of the generator 313. The discriminator function d(x, y) may be configured to obtain the output x*ᵢ and the hybrid channel data yᵢ and output the probability that (x*ᵢ yᵢ) being the same data pair as the original (xᵢ, yᵢ). In other words, the discriminator function d(x, y), or the discriminator 315, provides the probability P that if the missing channel is reconstructed successfully by the generator 313, or the generator function g(y, z), based on the partial channel knowledge and precoder information in the CSI-feedback 220.

The presented training techniques may be applied to training the generative model 300. Any losses of the generator 313 and/or the discriminator 315 for the data sample (z, xᵢ, yᵢ) may be computed based on cGAN loss functions. In some embodiments, the generator 313 and discriminator 315 may be configured to conduct a gradient update based on the corresponding loss functions.

Once the training converges to an equilibrium, the generator 313, or the generator function g(y, z), is deployed as the generative model 300 or the generative function 310.

Once the generative model 300 is deployed, the gNB 20 may configure third reference signals transmitted by the UE device 30 such that part of the channel bandwidth is sounded. In addition to this, the gNB 20 may configure a fourth reference signal transmitted to the UE device, and trigger CSI reporting based on the third reference signal such that CSI feedback 220 for the other part of the bandwidth is generated and transmitted by UE device 20 to the gNB. The deployed estimator, i.e. the generative model 300, at the gNB 20 receiving the third reference signals in and the CSI-feedback associated with the fourth reference signals, utilizes the channel estimation 230 (partial UL channel data set 230) at the sounded bandwidth, the precoder information 220 (partial DL channel data set 220) in the CSI feedback, and the random sampled data point z, rendering the reconstructed channel matrix for the part of bandwidth where only CSI feedback is obtained.

In one embodiment, spatial channel reconstruction based on based on partial channel sounding, providing the partial UL channel data set 230, and CSI-feedback, providing the partial DL channel data set 220, considered in a wireless system using NR RAT. This embodiment aims to reconstruct the transmission channel 200 in the frequency domain f based on the partial channel knowledge 220, 230 limited by a number of reference signal ports. Assume that the full channel matrix in the spatial domain is a stack (along the frequency dimension) of, the previously presented, 2D channel matrices with the dimension number of Tx antenna elements 112 by number of Rx antenna elements 112. The partial channel knowledge obtained at the Rx side is limited to only a subset of the matrix rows, e.g., row 1 and 2. The proposed solution aims to reconstruct the missing channel matrix for other rows, e.g., row 3 and row 4 based on the partial knowledge at row 1 and 2, as well as CSI-feedback.

In order to obtain data for training the generative function 310, a gNB 20 of the wireless system 10 may configure first reference signals such that first reference signals (e.g., SRS) are transmitted for all transmission antenna elements 112 at a UE device 30 of the wireless system 10. As previously mentioned, this step may not be feasible for low-end UE devices 30 where the number of transmission antenna elements 112 are limited. Therefore, this step may be selectively applied to higher end UE devices 30 in which a number of receiving and transmission antenna elements 112 are equal, or other wireless devices 30 such as UE devices 30 which are designed particularly for data collection, e.g. a testbed.

The gNB 30 may configure a second reference signal (e.g., CSI-RS) which is transmitted to the UE device 30 and CSI-report based on the second reference signal, such that the CSI-feedback is generated at the UE device 30 and transmitted by the UE device 30 to the gNB 20. It may be worth noting that in some applications, the gNB 20 may configure a fixed rank CSI-report for training data acquisition such that the reported rank, e.g. fixed rank 3 or rank 4, is greater than the assumed number of transmission antennas at the UE device 30, e.g., rank 2.

As with the previous example, the gNB 20 performs channel estimation based on the received first reference signals, i.e. the partial UL channel data set 230, in order to obtain channel estimation for the whole bandwidth. This is to provide the ground-truth data in the training phase. The gNB proceeds to decode the CSI-feedback, i.e. the partial DL channel data set 220.

In order to formulate a training set, a selection of CSI-feedback and estimations is performed. This implies, for each time interval, if the rank indicator is larger than the rank limitation, 2 in the above specific case, both the channel estimation and CSI-feedback is kept in the training data set. Otherwise, data is not used. All the channel estimates from the missing target antenna ports, e.g., H3 and H4, are labeled as data samples in the channel data set target X. All the channel estimates from the other antenna ports, where the reference signal will be transmitted in the execution phase, e.g, H1 and H2, as UL data samples h, and all the precoders from the CSI-feedback, as DL data samples p. The indices are arranged such that xᵢ, hᵢ, pᵢ represent the channel knowledge for the same time range, e.g., the same 5 ms interval. The UL data samples hᵢ and the DL data samples pᵢ are concatenated to form a new hybrid channel data yᵢ in the new sample space of the hybrid channel data set Y. The formulated data set X, Y may be used in training the generative model 300.

The training of the generative model 300 is identical to that presented with reference to wideband channel reconstruction and is omitted in order to keep the present disclosure efficient.

Once the generative model 300 is deployed, the gNB 30 may configure third reference signals (e.g., SRS) transmitted by the UE device such that only a subset of the transmission antenna elements 112 are sounded. In scenarios with low-end UE devices wherein the number of transmission antenna elements 112 are physically limited by its implementations, the gNB 20 may configure the third reference signals (e.g., SRS) such that all transmission antenna elements 112 are sounded.

The gNB may configure a fourth reference signal (e.g., CSI-RS) transmitted to the UE device 30, and trigger CSI reporting based on the fourth reference signal such that CSI feedback is generated and transmitted by the UE device 30 to the gNB.

The deployed estimator, generative model 300, at the gNB 20 receiving the third reference signals and the CSI-feedback in response to the fourth reference signals may take the channel estimation based on that reference signal, the precoder information in the CSI feedback, and the random sampled data point z, rendering the reconstructed channel matrix 210 for the antenna ports missing from the third reference signal. This may be considered valid only when the rank indicator in the CSI feedback is greater than the number of sounded antenna ports from the third reference signal. Otherwise, the deployed estimator 300 is regarded as a fake, faulty, poor etc. reconstruction.

As is evident to the skilled person after digesting the teaching of the present disclosure, these teachings will significantly enhance the DL beamforming performance. In addition to this, a reference signal overhead of a communications system will be reduced. Further to this, scheduling decisions will be significantly enhanced if the teachings are implemented at a network node with scheduling capabilities. The skilled person will also conclude that the teachings of the present disclosure are indeed sound. For instance, the precoder information from the CSI-feedback provides an approximation towards a channel's dominating subspace and singular vectors for that the missing part of the channel knowledge. The partial channel knowledge obtained from reference signals is likely to be correlated with the missing part of the channel knowledge. Therefore, the underlying random process that governs the obtained partial channel knowledge provides certain information regarding the missing channel knowledge. Furthermore, it is likely that the singular vector distributions and the singular value distributions of the missing channel and the partial channel are correlated. Also, reconstructing a random matrix needs information for both singular values and singular vectors. The generation function which takes the input of singular vectors and output the channel matrix is a one-to-many mapping. Therefore, aiming to reconstruct the channel matrix purely based on precoder information is likely to be infeasible. The reason is that there exist infinitely many singular value distributions so that the singular vectors can be combined linearly infinitely many ways. Further to this, conditional on the partial channel knowledge which provides the singular value and vector information, and the precoder from CSI-feedback which provides the singular vector distribution of the missing channels, a conditional generative model 300 may therefore narrow down its output range for better reconstruction of the missing channels.

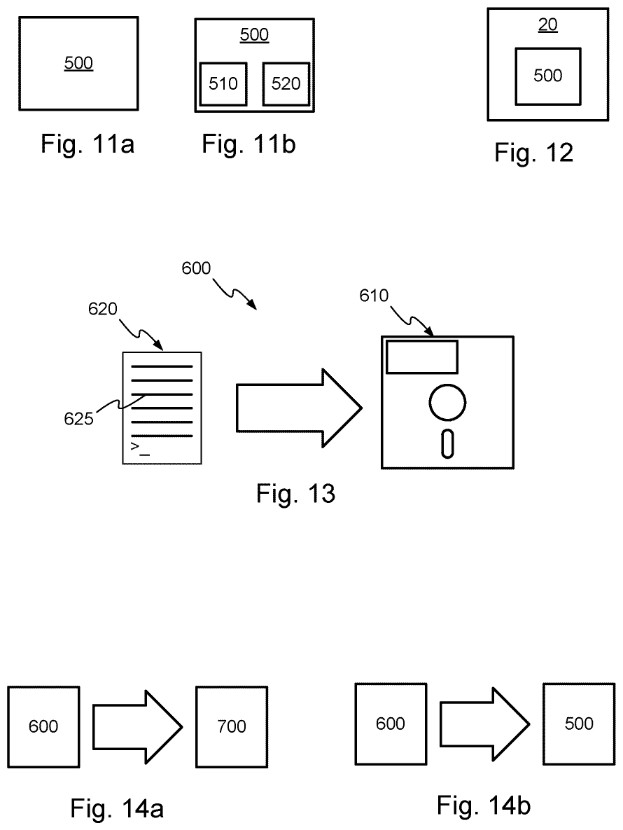

Turning briefly to FIGS. 11a and b, an apparatus 500 for modeling the wireless transmission channel 200 is shown. The apparatus 500 may comprise, or be operatively connected to a means for (wireless) communication 510 and one or more memories 520 for storing instructions executable by the apparatus 500. The apparatus 500 may in some embodiments be a controller 500 which may be stand alone or comprised in other devices.

The apparatus 500 may be configured to cause execution of the method 400 and features described with reference to FIGS. 5 to 10 or any other features presented within the present disclosure. That is to say, the apparatus 500 may orchestrate the execution of, by one or more other entities, execution of the method 400 and features described with reference to FIGS. 5 to 10 or any other features presented within the present disclosure. In some embodiments, the apparatus 500 may be configured to perform one or more of the steps of method 400 and features described with reference to FIGS. 5 to 10 or any other features presented within the present disclosure. In some embodiments, the apparatus 500 is configured to perform the method 400 and features described with reference to FIGS. 5 to 10 or any other features presented within the present disclosure.

FIG. 12 illustrates a control node 20 comprising the apparatus 500 of any of the embodiments described above. In one embodiment, the control node 20 is a network node 20. In one embodiment, the control node 20 is a gNB. The control node 20 may be the control node 20 according to any embodiment of the wireless system 10 described within the present disclosure, and particular with reference to FIG. 1a.

FIG. 13 shows a computer program product 600. The computer program product 600 comprises a non-transitory computer readable medium 610, illustrated as a vintage 5.25 inch floppy disc in FIG. 610. On the non-transitory computer readable medium 610, a computer program 620 is stored. The computer program 620 comprises instruction 625. When the computer program 620 is loaded into a data processing unit 700, see FIG. 14a, and the computer program 620 is run by the data processing unit 700, the instructions 625 will cause execution of, parts of, or the whole method 400 and features described with reference to FIGS. 5 to 10 or any other features presented within the present disclosure.

FIG. 14a is a schematic view illustrating the computer program product 600 being loaded onto the data processing unit 700, and FIG. 14b shows a corresponding illustration of the computer program product 600 being loaded onto the apparatus according to any embodiment described herein.

Modifications and other variants of the described embodiments will come to mind to one skilled in the art having benefit of the teachings presented in the foregoing description and associated drawings. Therefore, it is to be understood that the embodiments are not limited to the specific example embodiments described in this disclosure and that modifications and other variants are intended to be included within the scope of this disclosure. For example, while embodiments of the invention have been described with reference to modeling of a wireless transmission channel, particular a NR transmission channel, persons skilled in the art will appreciate that the embodiments of the invention can equivalently be applied to any other RAT, and any other form of transmission channels including, but not limited to, optical fibers etc. Furthermore, although specific terms may be employed herein, they are used in a generic and descriptive sense only and not for purposes of limitation. Therefore, a person skilled in the art would recognize numerous variations to the described embodiments that would still fall within the scope of the appended claims. Furthermore, although individual features may be included in different claims (or embodiments), these may possibly advantageously be combined, and the inclusion of different claims (or embodiments) does not imply that a combination of features is not feasible and/or advantageous. In addition, singular references do not exclude a plurality. Finally, reference signs in the claims are provided merely as a clarifying example and should not be construed as limiting the scope of the claims in any way.

1. A method (400) for modeling a wireless transmission channel (200), the method (400) comprising:
obtaining (420) a partial uplink, UL, channel data set (230),
obtaining (430) a partial downlink, DL, channel data set (220),
processing (440) the partial UL channel data set (230) and the partial DL channel data set (220) to provide reconstructed channel data set (210) for UL and DL,
providing (450) said reconstructed channel data set (210) for UL and DL for subsequent communication (460) in a wireless system (10).

2. The method (400) of claim 1, wherein the partial UL channel data set (230) is a partial UL channel matrix (230) obtained based one or more Sounding Reference Signals, SRS, relating to the UL.

3. The method (400) of claim 1, wherein the partial DL channel data set (220) is obtained based one or more channel state information, CSI, feedback relating to the DL.

4. The method (400) of claim 3, wherein the CSI feedback is Type-I codebook based feedback and/or Type-II codebook based feedback.

5. The method (400) of claim 1, wherein processing (440) the partial UL channel data set (230) and the partial DL channel data set (220) comprises applying (445) a generative model (300) comprising a generative function (310) with the partial UL channel data set (230) and the partial DL channel data set (220) as inputs.

6. The method (400) of claim 5, wherein the generative function (310) is a feedforward neural network (310).

7. The method (400) of claim 5, further comprising training (410) the generative model (300).

8. The method (400) of claim 7, wherein training (410) the generative model (300) comprises iteratively:
mapping (413) a channel data set target (X) to a hybrid channel data set (Y) comprising UL channel data (235) not comprised in the partial UL channel data set (230) and/or DL channel data (225) not comprised in the partial DL channel data set (220), and
mapping (417) the channel data set target (X), the partial UL channel data set (230) and the partial DL channel data set (220) to a probability measure (P),
until a convergence criterion is met and then:
providing (418) a generative function (310) based on the hybrid data set (Y).

9. The method (400) of claim 8 wherein mapping (413) the channel data set target (X) further comprises mapping (415) the channel data set target (X) to a random variable (Z).

10. The method (400) of claim 9, wherein the random variable (Z) is sampled from a multi-dimensional Gaussian distribution.

11. The method (400) of claim 1, wherein said subsequent communication (460) in the wireless system (10) comprises beamforming (465) at least one of a UL transmission or a DL transmission based on the reconstructed channel data set (210).

12. The method (400) of claim 1, wherein the transmission channel (200) comprises a plurality of sub-channels (205) and the partial UL channel data set (230) is limited to a subset of said plurality of sub-channels (205).

13. The method (400) of claim 1, wherein the transmission channel (200) comprises a plurality of sub-channels (205) and the partial DL channel data set (220) is limited to a subset of said plurality of sub-channels (205).

14. The method (400) of claim 12, wherein the sub-channels (205) are configured with different center frequencies (fc).

15-18. (canceled)

19. An apparatus (500) for modeling a wireless transmission channel (200), wherein the apparatus is configured to cause:
obtaining of a partial uplink, UL, channel data set (230),
obtaining of a partial downlink, DL, channel data set (220),
processing of the partial UL channel data set (230) and the partial DL channel data set (220) to provide reconstructed channel data set (210) for UL and DL,
provisioning of said reconstructed channel data set (210) for UL and DL for subsequent communication in a wireless system (10).

20. The apparatus (500) of claim 19, wherein the apparatus (500) is configured to perform the method (400) of any one of the claims 1 to 18.

21. A control node (20) comprising the apparatus (500) of claim 19.

22. The control node (20) of claim 21, wherein the control node (20) is a network node (20).

23. A wireless communication system (10) comprising the control node (20) of claim 21.

24. A computer program product (600) comprising a non-transitory computer readable medium (610), having thereon a computer program (620) comprising program instructions (625), the computer program (620) being loadable into a data processing (700) unit and configured to cause execution of the method (400) according to claim 1 when the computer program (520) is run by the data processing unit (700).
